(19) United States
(12) Patent Application Publication
(10) Pub. No.: US 2008/0048078 A1
(43) Pub. Date: Feb. 28, 2008

(54) Beam-column clamp

(76) Inventor: Vincenzo Gentile, Toronto (CA)

Correspondence Address: BERESKIN AND PARR, 40 KING STREET WEST, BOX 401, TORONTO, ON, M5H 3Y2, CA

(21) Appl. No.: 11/639,188

(22) Filed: Dec. 15, 2006

(30) Foreign Application Priority Data
Dec. 20, 2005 (CA) 2530902

(51) Int. Cl. F16B 17/00

(52) U.S. Cl. 248/219.2

(57) ABSTRACT

An apparatus for clamping a beam to a first end of a column is disclosed. The apparatus includes first and second clamping members positioned in opposed relation to each other. The first and second clamping members include hook portions to clamp the beam. First and second legs project downwardly from the first clamping member and the second clamping member, respectively. A notch is defined in the first leg. The notch receives the second leg. The first and second legs are received within the first end of the column such that the second leg is prevented by the column from disengaging from the notch of the first leg.

### FIELD OF THE INVENTION

This invention relates to building construction, and in particular, to a clamp for securing a beam to a column.

### BACKGROUND OF THE INVENTION

In the building construction process, it is typically necessary at some point to securely connect a beam to a column. One known beam to column connection, particularly useful for securing metal beams to metal columns, requires welding the beam to the column.

This prior art beam-column connection has numerous disadvantages. One of these disadvantages is that the use of welding equipment on construction sites creates a significant risk of fire. This in turn increases the cost of construction by increasing the cost of insurance.

Accordingly, there is a need for a beam column connection which does not require welding.

### SUMMARY OF THE INVENTION

The present invention provides an improved beam-column clamp which permits a beam to be secured to a column without welding.

According to a first aspect of the invention, an apparatus for clamping a beam to a first end of a column is provided. The apparatus comprises first and second clamping members positioned in opposed relation to each other, wherein the first and second clamping members are adapted to clamp the beam. First and second legs project downwardly from the first clamping member and the second clamping member, respectively. A notch is defined in the first leg. The notch is adapted to receive the second leg. The first and second legs are adapted to be received within the first end of the column such that the second leg is prevented by the column from disengaging from the notch of the first leg.

### BRIEF DESCRIPTION OF THE DRAWINGS

In the accompanying drawings:

FIG. 1 shows an exploded perspective view of a preferred embodiment of the present invention;

FIGS. 2A-F show various views of the clamping member of the preferred embodiment;

FIG. 3 is a partial cross-sectional view of the preferred embodiment; and

FIGS. 4A-D are a series of perspective views illustrating the operation of the preferred embodiment.

### DETAILED DESCRIPTION OF THE INVENTION

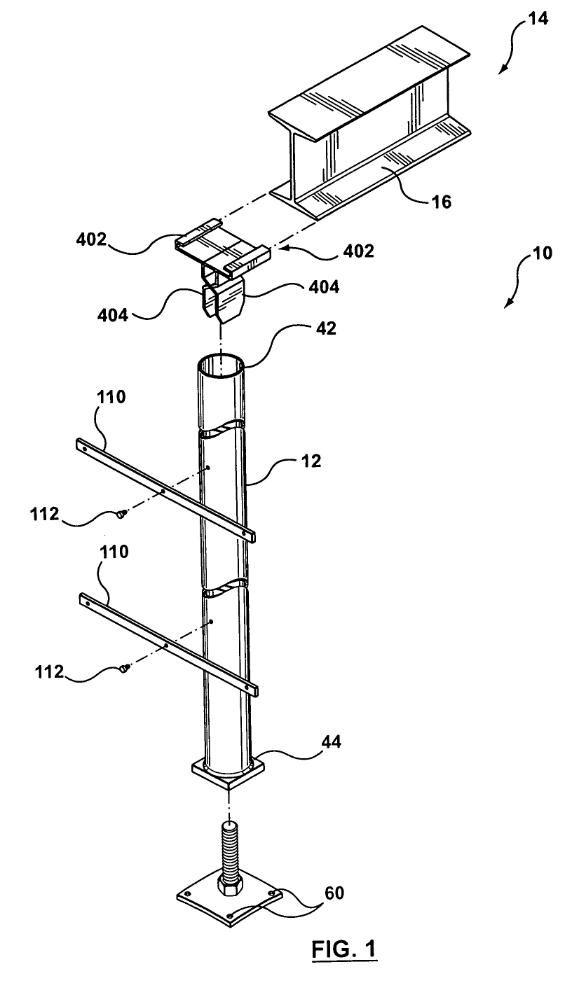

FIG. 1 shows a beam-column clamp apparatus 10 for clamping a beam 14 to a column 12 according to a preferred embodiment of the present invention. The column 12 may have a first end, such as upper end 42, and a second end, such as lower end 44 which rests on a surface. The beam-column clamp apparatus 10 is particularly suited for securing an I-beam or other beam having a flange 16 to the column 12, which preferably has a hollow cylindrical shape.

Continuing to Refer to FIG. 1, braces 110 may be secured to the column 12 using any suitable fasteners, such as a rivet 112. The braces 110 may be used to improve the stability of the column 12 by connecting it to other structural members, such as other columns.

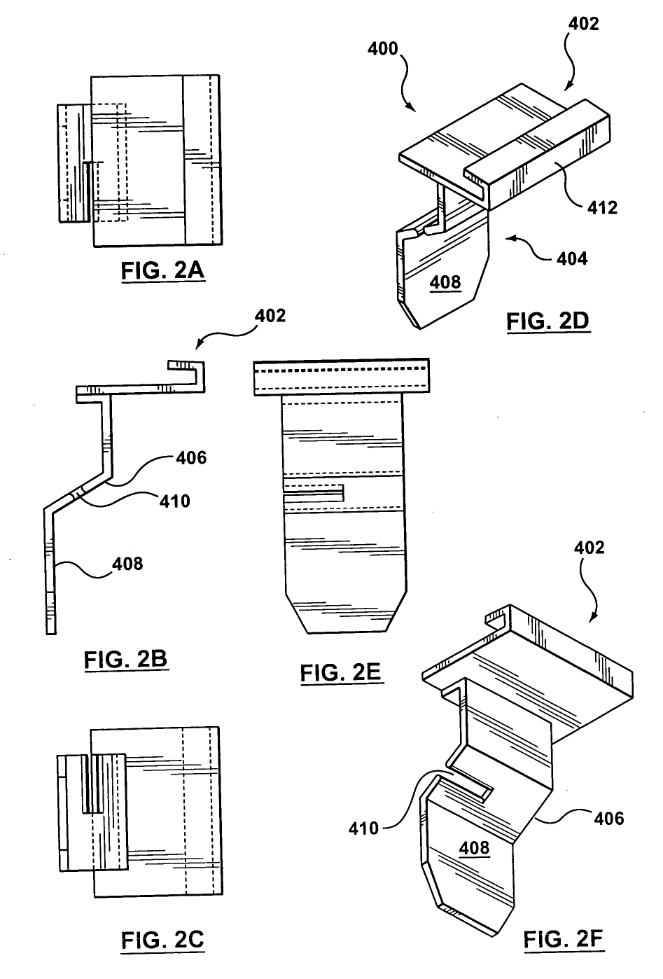

Referring to FIGS. 2A-F, the beam-column clamp apparatus 10 includes a pair of preferably identical clamping members 402. Each clamping member 402 includes opposing hook portions 412. A preferably integral leg 404 depends downwardly from each clamping member 402. Each leg 404 includes an upper inclined portion 406 and a lower portion 408 depending downwardly from the upper inclined portion 406. The upper inclined portion 406 includes a notch 410.

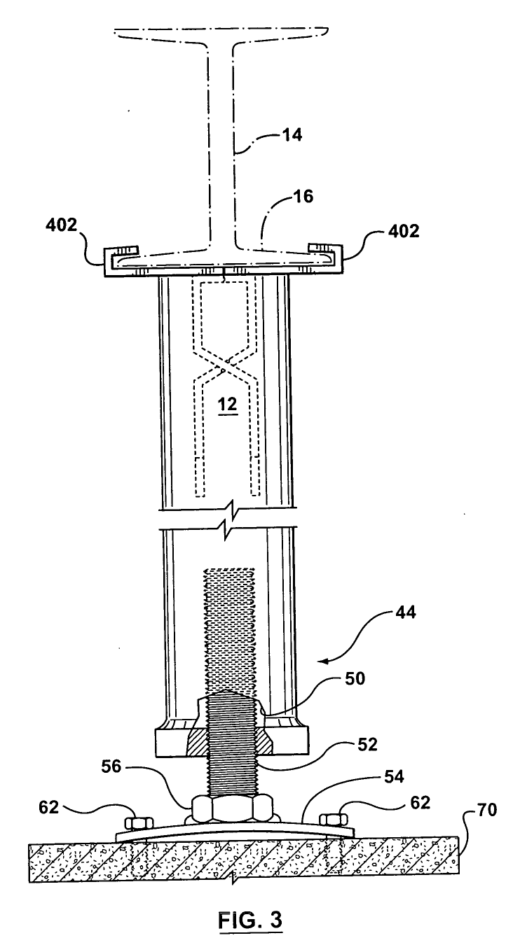

Referring now to FIGS. 1 and 3, the lower end 44 of the column 12 includes a threaded opening 50 which receives an upper end of a threaded adjustment rod 52. The lower end of the adjustment rod 52 is connected to a foot plate 54. An adjustment nut 56 is secured to the adjustment rod 52.

The foot plate 54 has a plurality of holes 60 to receive fasteners 62 to secure the foot plate 54 to a surface, such as a foundation 70. Preferably, the foot plate 54 has a curved or “dished” surface.

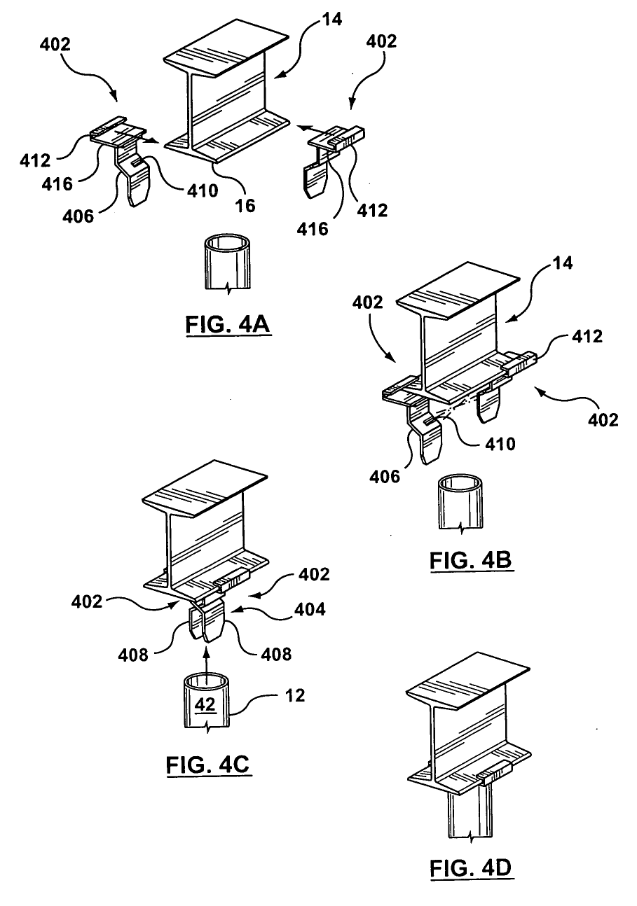

The operation of the preferred embodiment will now be described. As best shown in FIGS. 4A and 4B, each of the pair of clamping members 402 are placed on the beam 14 in offset relation, such that the hook portion 412 of each clamping member 402 engages the lower flange 16 of beam 14. Each hook portion 412 is preferably sized to snugly engage the flange 16. The clamping members 402 are slid toward each other along the beam 14, such that the upper inclined portion 406 of the leg 404 of one clamping member 402 is received within the notch 410 of the leg 404 of the other clamping member, as best shown in FIG. 4B. The upper end 42 of the column 12 is then positioned under the legs 404 and raised until the legs of each clamping member 402 are received within the upper end 42 of column 12, as best shown in FIGS. 4C and 4D. The upper end 42 of column 12 abuts against a central portion 416 of the clamping members 402.

Referring now to FIGS. 1 and 3, the threaded rod 52 is then turned using the nut 56 until the foot plate 54 is in contact with the foundation 70. The fasteners 62 are then used to secure the foot plate 54 to the foundation 70. As a result, the threaded rod 52 is prevented from rotating because it is secured to the foundation 70 at its lower end. The column 12 is prevented from rotating relative to the threaded rod 52, because to do so would require the column 12 to move vertically. The column 12 is prevented from moving vertically because it is secured to the flange 16 of the beam 14 at the column's upper end 42 by the clamping members 402.

The upward force exerted by the column 12 when fixed in place is sufficient to cause the clamping members 402 to resist sliding along the flange 16 of beam 14. The lower portions 408 of legs 404 are sized such that, when located within the column 12, they are prevented from rotating relative to each other, and thereby prevented from moving the clamping members 402 away from the beam 14.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. An apparatus for clamping a beam to a first end of a column, the column having a second end securable to a surface, the apparatus comprising:
a) a first clamping member and a second clamping member, wherein the first clamping member is in opposed relation to the second clamping member, wherein the first and second clamping members are adapted to clamp the beam;
b) a first leg projecting downwardly from the first clamping member and a second leg projecting downwardly from the second clamping member, the first leg defining a notch therein, the notch being adapted to receive the second leg
wherein the first and second legs are adapted to be received within the first end of the column such that the second leg is prevented by the column from disengaging from the notch of the first leg.

2. The apparatus of claim 2, wherein the second leg defines a notch therein, wherein the notch of the second leg is adapted to receive the first leg.

3. The apparatus of claim 3, wherein the notch of the first leg is in horizontal alignment with the notch of the second leg when the first and second clamping members are clamped on the beam.

4. The apparatus of claim 3, wherein the first and second leg each comprise an inclined portion, wherein the notch is defined in the inclined portion.

5. The apparatus of claim 4, wherein the first and second legs abut against an inner circumference of the column.

6. The apparatus of claim 5, wherein the first leg and the second leg are identical.

7. The apparatus of claim 8, wherein the second end of the column defines a threaded opening.

8. The apparatus of claim 9, further comprising:
a) a threaded rod received in the threaded opening; and
b) a foot plate connected to a lower end of the threaded rod, wherein the foot plate is adapted for being secured to the surface;
wherein the threaded rod is rotatable to bring the foot plate in contact with the surface.

9. The apparatus of claim 10, further comprising a nut secured to the threaded rod, wherein the threaded rod is rotated by turning the nut.

10. The apparatus of claim 11, wherein the foot plate has a dished surface.
